(19) United States
(12) Patent Application Publication
(10) Pub. No.: US 2003/0086566 A1
(43) Pub. Date: May 8, 2003

(54) Copyright protection system

(76) Inventor: Richard M Gooch, Surbiton (GB)

Correspondence Address: SCHNECK & SCHNECK, P.O. BOX 2-E, SAN JOSE, CA, 95109-0005, US

(21) Appl. No.: 10/089,007

(22) PCT Filed: Dec. 1, 2000
(86) PCT No.: PCT/GB00/04616

(30) Foreign Application Priority Data
Dec. 2, 1999 (GB) 9928558.7

(51) Int. Cl. G06F 17/60; H04K 1/00

(52) U.S. Cl. 380/200

(57) ABSTRACT

One embodiment of the invention relates to a digital data signal comprising: a first data set of source data (1) and control data (2), said source data being modified in accordance with said control data to generate an intermediate set (3) of modified data when said data signal is copied by equipment adapted to read data on a block by block basis; and a second data set (4) associated with said first data set, said second data set being provided to enable modifications made, or modifications that otherwise would be made to said first data set to generate said intermediate data set upon copying of said signal by said equipment, to be at least substantially negated. Other embodiments of the invention relate to a carrier having a data signal recorded thereon, to a method of generating such a data signal, to a method of copying such a signal, to a computer program, to data copying apparatus and to a data transfer system.

The present invention relates to digital data signals, and associated systems and methods for copy-control of digital content. One embodiment relates particularly to copy control of digital data carried on a data carrier such as a compact disc (CD). Other aspects of the invention provide copyright protection by restricting the reading or copying of digital data, principally but not exclusively digital audio, whilst providing access controls which enable authorised extraction and usage of the digital data.

A persistent problem in the field of consumer audio has been the difficulty of practically implementing the legal protection offered by copyright law for products of the recording industry.

Various copyright protection systems (such as the serial copy management system (SCMS) agreed between the recording industry and the consumer electronics (CE) industry) have previously been proposed to counter this problem and these systems have generally worked well. However, in recent times this problem has been exacerbated as the carriers (such as CD) used in the recording industry have become more widely used in other industries such as the computer and IT industries.

These industries have developed products (such as personal-computer (PC) based CD players and CD-R copiers for example) which incorporate the functionality of audio playing and copying equipment, but do not adhere to existing copyright protection systems such as SCMS. There is thus a general need for a new copy-protection system which provides copy-protection against general purpose equipment which services generic copying of data, it also being preferable to avoid having to modify such equipment to incorporate specific copy-protection systems such as SCMS.

One proposed solution lies in the development of entirely new data carriers and new equipment including players and copying devices, which carriers and equipment incorporate new copy-protection standards (An example is the development of DVD-Audio equipment and disc standards which describe audio watermarking and encryption means to facilitate copy-protection). However, such a solution is inconvenient and would probably be expensive to implement because there is a large established market and installed base of older equipment (particularly CD-Audio players) and products. It would therefore be desirable if a copy-protection system could be implemented which is compatible with existing standards, and thus should not impact upon normal legitimate usage nor require changes to the installed base of hardware.

It is an object of the invention to address the above mentioned problem(s), and to this end one aspect of the invention provides a digital data signal comprising: a first data set of source data and control data, said source data being modified in accordance with said control data to generate an intermediate set of modified data when said data signal is copied by equipment adapted to read data on a block by block basis; and a second data set associated with said first data set, said second data set being provided to enable modifications made, or modifications that otherwise would be made to said first data set to generate said intermediate data set upon copying of said signal by said equipment, to be at least substantially negated.

Another aspect of the invention relates to a data carrier having a first and a second data set of a digital data signal as described herein recorded thereon.

Another aspect of the invention relates to a method of generating a digital data signal as described herein, the method comprising the steps of: inserting control data into a first data set of source data, and providing in association with said first data set a second data set, wherein upon copying of said signal by equipment adapted to read data from said carrier on a block by block basis said source data is modified in accordance with said control data to generate an intermediate set of modified data and said second data set is provided to enable modifications made or modifications that otherwise would be made to said first data set upon copying thereof to be at least substantially negated.

A further aspect of the invention relates to a method of copying data from a carrier (as described herein) by means of a copy operation of equipment adapted to read data from said carrier on a block by block basis, the method comprising the steps of: copying said signal to cause said intermediate data set to be generated, accessing said second data set to retrieve data therefrom, and applying said retrieved data from said second data set to said intermediate data set to reverse modifications made in accordance with said control data upon copying of said signal.

Another embodiment of the invention provides a method of copying data from a carrier (as described herein) by means of a copy operation of equipment adapted to read data from said carrier on a block by block basis, the method comprising the steps of: copying data from said second data set, modifying said copy operation in accordance with said data copied from said second data set, and copying data from said first data set.

A further aspect of the invention relates to a computer program comprising one or more computer program software portions which when executed in an execution environment is configured to perform one or more of the method steps mentioned above.

A yet further aspect of the invention relates to data copying equipment operable to read data on a block by block basis from a digital data signal or a digital data signal recorded on a carrier as described herein, said copying equipment comprising means for maintaining an execution environment and a computer program as described herein executable in said execution environment.

Another aspect of the invention relates to a data transfer system comprising data storage means for a plurality of digital data signals as described herein, each of said data signals being associated with a respective set of source data; and transmission means for transmitting initially at least part of one or more of said first data sets to a receiving device, and subsequently transmitting second data sets associated with said transmitted first data sets.

Other preferred features of aspects of the invention are set out in the dependent claims.

At this juncture; and before embarking upon a specific description of preferred embodiments of the invention; it is useful for purposes of better understanding the invention to consider briefly a number of mechanisms by means of which such a system might be implemented, and the sometimes conflicting requirements for any such system.

It should also be noted that in the context of this application. “copying” should not be construed to mean that the data signal must be extracted from one storage medium and recorded on another. “Copying”, as used herein, is intended to encompass so-called transitory copying where data is read from a carrier into memory for subsequent rendering (as might happen when audio data is read from a CD by a CD-Rom drive for replay to a user via a speaker), as well as copying where data is extracted from one storage medium and recorded onto another storage medium (as might happen when data is read from a CD by a CD-ROM drive and subsequently written to another CD by a CD-R drive).

Specifications for CD-Audio discs and equipment are set out in the so called “Red Book” standard prepared by Philips Consumer Electronics B.V. and Sony Corporation and published as the “Compact Disc System Description”. Copy protection methods for CD-Audio may be implemented by producing CD-Audio discs which do not adhere to the Red Book standard for CD-Audio. Such non-compliance with the Red Book can be used to produce a copy-protected audio CD which protection does not prevent the audio CD from being played in a standard CD player but which protection disrupts the reading of digital data and hence the data extraction process by which audio data is copied from its original carrier, typically a CD, to a second carrier, typically a computer memory, a computer disk drive, or a CD-R disc.

There are many potential methods and mechanisms by means of which the protection of an original CD against extraction of data using general purpose copying equipment, such as CD and CD-R equipment installed in a computer, may be achieved. For example, the disc table of contents (TOC) could be manipulated by deliberately writing the starting address of the lead-out incorrectly in the TOC, much in advance of the actual starting address of the lead-out—thus preventing normal playing of the disc using PC based CD players which are often programmed to prevent access to data on the disc beyond the starting address of the lead-out.

In another example, data-structures can be placed on an audio CD which cause any PC based player to process the disc incorrectly, for example as a CD-ROM or as a multi-session disc. Such a “data structure” could comprise a short computer program which is inserted prior to the audio program area of the disk to disrupt or prevent the extraction of audio data using computer-based CD or CD-R equipment upon execution of the program. Such a program could be ‘hidden’ with respect to audio play operations by placing it in an ‘extended pre-gap’ on the disc.

As another example, one could manipulate the Red Book encoding standards in order to hinder digital data-extraction from the disc, for example when the disc is played in a certain class of reproducing equipment. For example the Red Book describes features of the CD encoding method by means of which time and index data are encoded in the ‘sub-code channels’. This time and point information facilitates, among other things, the digital data-extraction of blocks of audio data from the disc, but which information is itself of limited or no use in playing the disc in a standard CD player (principally because a standard CD player streams data from the disc, rather than reading it on a block by block basis). If this time and point information are written to the CD in certain ways which deliberately contravene the Red Book standard, then this may prevent accurate seeking of data blocks and frames during the extraction of digital audio data such that there will be errors in the extracted data which will cause audible artefacts upon playing the extracted data. However as noted the time and point subcode data is of limited use in playing an original CD in an audio player, therefore the original CD will not yield audible artefacts upon playing of that original CD.

It should be recognised, however, that the implementation of such a system without any form of access control could cause a problem because it could prevent extraction for legitimate usage of that data—such as the importation of that data into portable players (e.g. MP3 players) of the type being developed under the secure digital music initiative (SDMI), [SDMI Secretariat, c/o SAIC,10260 Campus Point Dr, San Diego, Calif. 92121, USA] and also the legitimate extraction of digital audio data for rendering through high-quality audio rendering systems such as the Meridian 800 Reference DVD/CD Player [produced by Meridian Audio Ltd, Stonehill, Stukeley Meadows. Huntingdon. Cambridgeshire, PE18 6ED, England].

It is therefore important for a copy-protection system for the products of the recording industry, for example, to be provided with access controls which provide for legitimate extraction of data.

From the above, it should be apparent that when designing a copy-protection system for digital data one should have the following factors in mind:

(1) the system should preferably be compatible with standard players (i.e. players which stream data from the disc);

(2) the system should provide effective protection against the extraction of digital content data for copyright infringing uses;

(3) the system should preferably be compatible with generic products of the computer and IT industries (i.e. players which read data on a block by block basis); and

(4) the system should provide access controls to enable extraction of data for legitimate applications.

A beneficial consequence of providing such a system is the avoidance of conflict between the requirements of the computer and IT industries to provide generic tools, and the legitimate requirement of the recording industry to provide practical protection against infringing use of its products.

Embodiments of the present invention will now be described, by way of example only, and with reference to the accompanying drawings, in which:

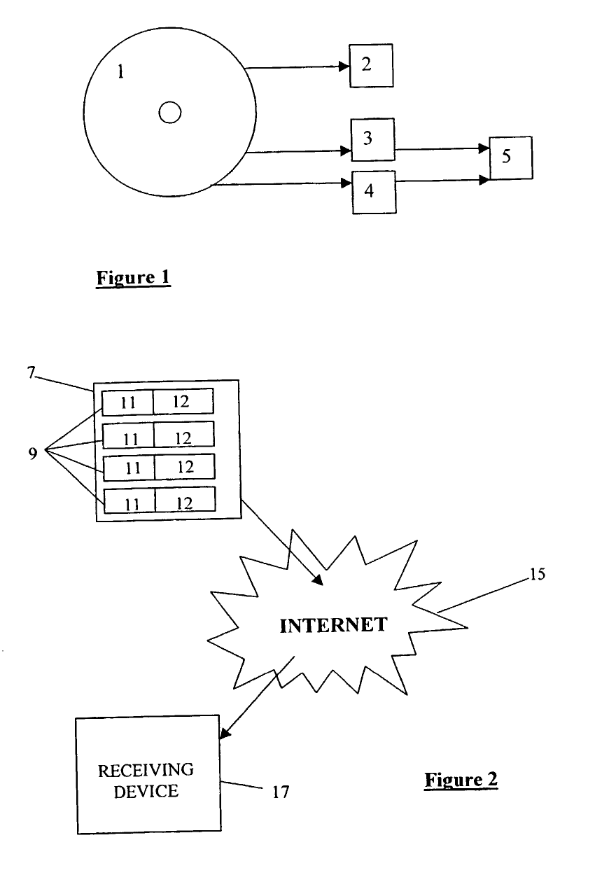

FIG. 1 schematically illustrates a data carrier;

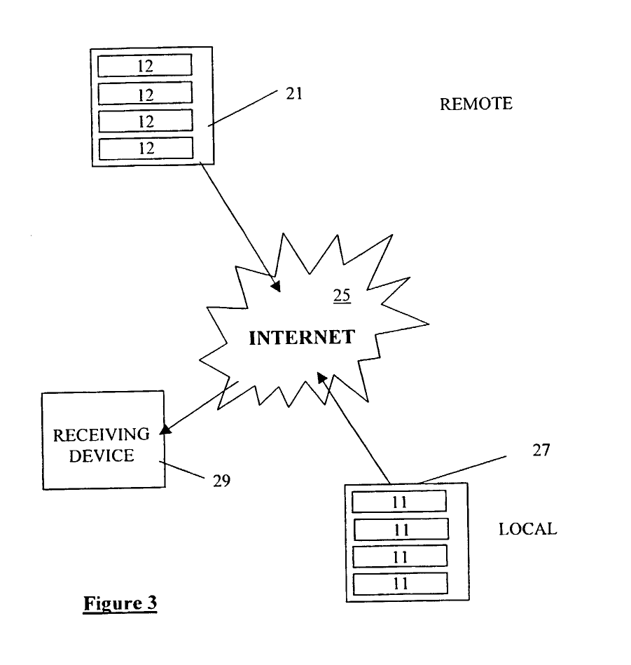

FIG. 2 schematically illustrates a data access system; and

FIG. 3 is a schematic representation of another data access system.

A first embodiment of the invention will now be described with particular reference to the application of the present invention in copy-protecting a digital data signal of an audio CD. However, it should be noted that the principles of the invention may be implemented on a variety of different storage media and therefore that this description should not be construed as limiting the scope of the invention.

FIG. 1 shows a data carrier 1 (which in this embodiment is a CD), which has recorded thereon a content file 2. In this embodiment, the content file comprises digital audio data which has been modified so that it is no longer compliant with the so-called “red-book” standard.

The precise form of modification is chosen so that it has little or no effect on the audio data content file 2 when data from the disc is read by a standard piece of audio equipment (such as a CD-player for example) which streams data from the disc, but yields an intermediate set of degraded data 3 (e.g. poor quality data) when attempts are made to read data from the disc using general purpose copying equipment (such as a PC-based CD-R) which reads data from the disc on a block by block basis.

To permit authorised reading of the audio data 2, for example as a precursor to copying onto an MP3 player or to permit reading of the data for playing or rendering via an audio speaker, an access control system 4 comprising a second set of data is also recorded on the carrier 1.

The access control system operates in conjunction with one or more computer program software portions which when executed in an execution environment maintained on the general purpose copying equipment (in this example a PC-based CD-R) access, once authorisation has been determined, the second data set to retrieve the data therefrom. Once the data has been retrieved the computer program operates either to apply the retrieved data to the degraded intermediate data set to reverse the modifications made upon copying or reading of the audio content file, or to apply the retrieved data to avoid the modifications that would otherwise be made upon copying or reading of the first data set. Authorisation may be determined, for example, by requesting input of an unlocking code or other decryption key, or by retrieving from a smartcard or other storage device a code or key imprinted thereon. In an alternative embodiment where the second data set contains a compressed copy of the whole of the source data, the computer program may simply extract (probably by means of a decryption and decompression process) the data from the second data set upon receipt of appropriate authorisation.

In other words, the access control system in one embodiment is such that it enables the above described data modification process (which occurs when unauthorised reading or copying of the data is attempted using equipment which reads data on a block by block basis) to be reversed so that a non-degraded copy 5 is yielded when authorised reading of data is attempted. As an alternative, the access control system could instead enable authorised users to avoid the modification of data that would otherwise take place when the content file 2 is read or copied.

It will be appreciated that this system advantageously does not require any modifications to be made to the general purpose copying equipment other than the addition of the above described computer program.

One particular form of “data modification” will be described below, but it will be appreciated that the form of modification chosen may be selected from a large number of alternatives.

For example, and as will later be described, the data modification may comprise a modification to the timing subcode information recorded on the carrier 1 alongside the audio data. Alternatively, the data modification may comprise the introduction of errors which are skipped when the carrier is played in a standard player (as a result of the Red Book standard for dealing with such errors), but which give rise to audible artefacts when copied with “non-Red Book” compliant devices such as PC-based CD-R devices for example—those audible artefacts being correctable (using data from the access control system 4) when legitimate copying of data is attempted.

In an alternative arrangement, the access control system 4 rather than containing a means for reversing the aforementioned “data modification process” could instead contain an encrypted (or otherwise protected) copy of all the audio data in the content file 2 in a non-modified form. The data stored in the access control system would preferably be compressed, for example using the PK Zip compression format, to reduce the amount of space it takes up on the data carrier 1.

In such an arrangement the copy-protected content file 2 could still be played in a conventional player, and would still give rise to artefacts if unauthorised copying were attempted. Data stored in the access control system 4, on the other hand, could be decrypted (and preferably decompressed) upon attempted authorised copying and upon recognition of the appropriate decryption keys.

Generally speaking, therefore, this first embodiment of the present invention can be implemented as a data-storage system comprising a physical carrier such as a CD which carries a first content file of data, the first content file being protected by a copy-protection system which restricts access to the first content by causing data-errors to be introduced into data extracted from the carrier, the data-storage system providing controlled access to the first content file by providing a second content file of data which is used to correct data-errors in the data extracted from the first content file.

It should be understood that the term ‘content file’ should not be construed narrowly, but instead broadly to cover terms such as ‘content’, ‘data’ and ‘content file of data’ and in particular, but not exclusively, to recording-industry content such as audio data or audio data in combination with additional data including text, graphics, software or video data.

It should also be understood that the term ‘data carrier’ is intended to cover any physical media used to carry any content file of data particularly, but not exclusively, optical disc media including CD, CD-R, DVD-Audio and MiniDisc as well as glass masters, stampers, mothers or any other tools used for production of such media.

It is recognised that a copying process by which a first content file on a first carrier is copied to an equivalent content file on a second carrier implies subsidiary processes under which data is extracted from the first carrier and transferred to the second carrier, and which processes operate on data which may in whole or in part represent the first content file, such that the extraction and transfer processes may be carried out repeatedly with respect to portions of the first content file until a complete copy of the first content file is present on the second carrier. Such a copying process should be construed as falling within the scope of the invention. By introducing data-errors into data extracted from a carrier, the copy-protection system prevents a first content file stored on a first data carrier from being reproduced as an equivalent content file on a second data carrier, since by introducing degradations or detrimental modifications into data extracted from the first content file then these degradations or detrimental modifications will be present in the content file stored on the second carrier where they were not present in the first content file stored on the first carrier.

The terms “modification”. “detrimental modification” and “degradation” are intended to cover, amongst other alternatives, any detectable reduction in quality, with respect to a first content file of data, of any copy of that first content file of data. In particular with respect to a file of audio data, such detrimental modification or degradation should, upon playing or otherwise rendering the copy of the first content file, result in the presence of detectable audible artefacts in the audio, where these audible artefacts were not present upon playing or rendering the first content file.

An initial step in the commercial production of CD-Audio discs involves the use of a laser beam recorder (LBR) in recording a first content file, in this example containing audio “tracks”, onto a glass-master. From the glass master are produced a number of intermediate tools for producing CD's by the injection-moulding process, and in particular are produced ‘stampers’ which incorporate a pattern of pits and lands which encode the audio tracks as well as subcode information. Stampers are used within an injection moulding machine to mould optical polycarbonate substrate material which forms the bulk of the produced CD disc.

The copy-protection scheme is employed at this glass mastering stage of production in order to protect the subsequently produced CDs against unauthorised copying using CD-R recording equipment. For example and as described above, one such copy-protection technique is to record the absolute time in the sub-code channel so that the absolute time is non-monotonic in at least one part of the information area of the disc. Thus in a preferred embodiment the LBR is controlled to write the absolute time in a pre-determined non-monotonic fashion which will have little or no impact on the normal operation of a subsequently produced CD when that CD is played in an audio CD player (because the player streams data from the disc), but which will disrupt the digital extraction of data from that CD using a PC based CD-ROM drive (because such a drive extracts data on a block-by-block basis).

Such a copy-protection technique will thus protect against digital data extraction using PC equipment and therefore protect against the production of infringing copies of the original CD using a CD-R recorder. However, a problem is that it will therefore not be possible to extract data from the protected CD for legitimate purposes such as for playing in an SDMI portable device player.

Therefore according to the present invention, a second file of data is encoded into the subcode channel and recorded by the LBR onto the glass master. This second file contains extracts of data copied from the portions of the first content file corresponding to those portions of the first content file at which the absolute time is recorded non-monotonically on the glass master.

The second content file may be encoded in the subcode channel in locations which correspond to areas on the glass master at which the absolute time is recorded monotonically. Thus a CD produced from this glass master can play normally in the majority of audio CD players which do not refer to the absolute time data encoded in the subcode channel during normal play operation. However, upon extracting digital data from the disc using the majority of PC based CD-ROM drives there will be errors in the extracted data corresponding to those points at which the absolute time was recorded non-monotonically. In the present embodiment, by subsequently extracting the corresponding portions of the first content file which were provided in the second content file encoded in the sub-code channel, the errors in the extracted data may be repaired to provide a substantially error-free copy of the first content file.

Preferably, the number of points at which the absolute time is recorded non-monotonically is sufficiently few in number that there is sufficient storage capacity in the subcode channel to store a second content file which contains all the data required in order to repair all errors arising in the extraction process.

Preferably, the number of points at which the absolute time is recorded non-monotonically is sufficiently many in number that the consequent errors arising in data extracted without the benefit of repairs afforded by the second content file, are of sufficient number that they represent a significant degradation of the quality of the extracted data with respect to the original data contained in the first content file. Advantageously, where the first content file contains audio tracks and data extracted from the first content file is not corrected using the second content file, then upon playing or rendering the extracted data there should be clearly audible degradation of the audio tracks represented by that data.

Advantageously, audio compression methods such as MP3 compression developed by the Fraunhofer IIS, Fraunhofer Institut für Integrierte Schaltungen, Am Weichselgarten 3, D-91058 Erlangen. Germany, or MLP compression developed by Meridian Audio Ltd, may be employed to compress audio content contained in the second content file, such that a greater quantity of audio data may be contained in the storage capacity provided by the sub-code channel, thus increasing the amount of data available for repairing errors, and consequently increasing the number of points at which error-inducing copy-protection may be applied to the first content file.

An alternative embodiment is provided where the second content file is encoded in the program area of the media. A typical audio CD can store 74 minutes of audio in the program area, yet many CD products provide less than 74 minutes of content material, therefore on such discs there is space in the program area to store a second content file.

As will be appreciated by a skilled reader there are yet further embodiments providing a data-storage system which uses a means of encoding a first content file and second content file onto a first data carrier, arranged to provide a method of extracting both the first and second content files, and a method of combining them to result in a copy of the first content file which is not degraded or otherwise modified.

FIG. 2 illustrates an arrangement which is particularly well suited for implementation via an internet or other data communication means, for example in a commercial environment.

In this embodiment, a data store 7 is provided with audio and/or video data sets 9 for a plurality of CDs, each of those data sets comprising a first set of modified data 11 and a second set of data 12 for reversing those modifications. Data extracted from the store is passed to an internet 15, and subsequently to a receiving device 17 connectable to that internet and which could, for example, be an MP3 player built into a Wireless Applications Protocol (WAP) enabled cellular phone.

The data received at the receiving device would be modified, and could for example comprise a low quality copy (i.e. low audio quality copy) of original data from which the modified data is generated.

In this way, it would be possible for a user of the receiving device 17 to receive a low quality copy of the data, for example as an evaluation copy, before requesting (and possibly paying for) a second file to be transmitted which enables the “modification” applied to the original data to be reversed. Such a mechanism would enable a so-called “try before you buy” process to be implemented. In this arrangement, access to the second files (at least) could be restricted for example by means of an encryption until payment or other authorisation had been received.

As a modification to this embodiment, and as an alternative to transmitting the modified data in its entirety, a representative sample of data for one or more of the CDs could instead be transmitted for evaluation.

In either case, it is preferred that data compression algorithms are utilised to reduce the size of the information to be transmitted.

It will also be appreciated that the principles of this embodiment do not require an internet 15 for operation, as the link could be cellular, via satellite, or simply wired.

FIG. 3 illustrates a further arrangement which is similar to that of FIG. 2, but which may enable the total time taken to transfer data to be reduced.

As shown, the system comprises a remote data store or server 21 (which is preferably a web server) connectable to an internet 25. A local data server 27 is also connectable to the internet 25, and data can be transferred from the local server 27 and the remote data store 21 to a receiving device 29 via the internet 25.

A user of the receiving device 29 in this embodiment, is able to transfer one or more sets 11 of modified data from the local store 27, and if authorised to transfer a second (typically much smaller) set of data 12 from the remote store 21 to reverse the modifications made to the modified data from the remote store 21. In this way, it is often possible to speed data transfer to the receiving device since the bulk of the data can be retrieved from a local store rather than a remote store.

In this embodiment, the terms “local” and “remote” should not necessarily be construed to imply discrete physical locations, but instead to imply simply that the channel between the local store and the receiving device is capable of achieving a greater data through-put than the channel between the remote store and the receiving device.

It should also be noted that the provision of an internet for communication between the servers and the receiving device is not essential. For example, the second data file (which is used to reverse the data modification) could be supplied on a smart-card or other storage device which may be plugged into the receiving device as required.

Generally speaking, therefore, these embodiments of the present invention provide a means of access to the second file of data through a controlled access system, such that whereas access to the second content file is required in order to access any content file equivalent to the first content file, then the first content file is effectively the subject of the access control system. Thus copying of the first content file to a second carrier may be controlled by the access control system on the basis, for example, of whether the copying process is determined to be authorised and whether the second data carrier is determined to comply with requirements specified under the terms of an authorised copying process. Preferably, access to the second content file is protected by a system of encryption with controlled access to decryption keys. Advantageously the second content file can be carried on a carrier using an encoding method to which itself is the subject of access controls, for example under the terms of a license governing usage criteria associated with the encoding method and governing any related extraction and decoding method.

The second carrier may be any physical medium including, but not limited to CD-R. CD-RW. DVD-RAM, any computer memory system including RAM. Flash Memory, any disc storage system, and further the second carrier may be a virtual-memory system such as a paged memory or cache memory which virtual-memory is implemented using a physical medium.

As mentioned above, in another embodiment of the invention, there is provided a copy-protection system with access controls which uses a data-storage system comprising a first physical carrier such as a CD and a first content file of data carried by the first data carrier, the first content file being protected by a copy-protection system which restricts access to the content by causing data-errors to be introduced into data extracted from the first carrier, the data-storage system providing controlled access to the content by providing a second content file of information which is used to correct data-errors in the data extracted from the first content file.

In other words, in this embodiment a degraded copy of the first content file is stored on an intermediate carrier such as a CD, flash memory, cache memory or in particular a web server or web cache, and the second content file of data is stored on a separate carrier such as a smart-card or a web server, such that the second content file is the subject of a secure access control system, whilst degraded copy of the first content file is held on a high-capacity storage system which may be held locally or available remotely over a wide-bandwidth connection. Such an embodiment is of interest in e-commerce systems which are required to protect content files on a server or cache and to provide access to that content under the terms of a transaction. The present embodiment supports this process by providing access to a degraded or partially incomplete copy of a first data file on a publicly accessible web-server or web-cache whilst providing controlled access to a second file of data which is required in order to yield a complete copy of the first content file. It will be appreciated by those skilled in the art that benefits in terms of efficient caching of large content files, and reduced encryption overheads, and limited preview models, are all facilitated by this embodiment.

It will be understood from the above that a large number of modifications may be made to the various embodiments described herein. All of these embodiments should be construed to fall within the scope of the claims.

It should also be noted that the scope of this invention is intended to extend to any data-storage system arranged to provide a physical carrier which stores or encodes a first content file protected with a copy protection system together with a second content file which may be used to repair a degraded copy of the first content file. Embodiments of this invention further extend to any carrier which carries a first content file and which carries a second content file for the purpose of repairing a degraded copy of the first content file; to any second content file on any carrier which file is provided for the purpose of repairing any copy of a first content file which first file might be degraded as a consequence of being copied; to any carrier which carries a second content file which file may be used to repair a degraded copy of a first content file; to any file of data stored on any carrier, which data has been produced as a result of repairing a degraded copy of a first content file using a second content file; to any carrier which carries a content file which content file has been produced as a product of the process of repairing a degraded copy of a first content file using a second content file; to any method and process for preparing a second content file for the purposes of repairing a degraded copy of a first content file; and to any process or method or apparatus or equipment by which a degraded copy of a first content file may be repaired using any second content file, whether a physical apparatus or a computer program or process which implements the function of that apparatus.

This invention also extends to any tools for example glass-masters, produced directly for the purpose of manufacturing an embodiment of data-storage systems or copy-protection systems according to this invention, including intermediate tools, for example mothers and stampers required at intermediate stages in the production of CDs, which tools or intermediate tools are used for the purpose of manufacturing an embodiment of data-storage systems or copy-protection systems according to this invention.

1. A digital data signal comprising:
a first data set of source data and control data, said source data being modified in accordance with said control data to generate an intermediate set of modified data when said data signal is copied by equipment adapted to read data on a block by block basis; and
a second data set associated with said first data set, said second data set being provided to enable modifications made, or modifications that otherwise would be made to said first data set to generate said intermediate data set upon copying of said signal by said equipment, to be at least substantially negated.

2. A digital data signal according to claim 1, wherein access to said second data set is controlled.

3. A digital data signal according to claim 1 or 2, wherein said second data set is encrypted, access to said second data set only being permitted once the second data set has been decrypted with an appropriate key.

4. A digital data signal according to any preceding claim, wherein said intermediate data set is degraded, for example of lower quality, with respect to said first data set.

5. A digital data signal according to any preceding claim, wherein said control data is such that copying of source data without generation of said intermediate data set is enabled when said digital data signal is copied by data reading equipment operable to stream data from a data signal.

6. A digital data signal according to any preceding claim, wherein said source data comprises audio and/or video data.

7. A digital data signal according to any preceding claim, wherein the second data set comprises an encrypted copy of at least part of said source data.

8. A digital data signal according to any preceding claim, wherein the second data set comprises an encrypted and possibly compressed copy of the whole of said source data.

9. A data carrier having a first and a second data set of a digital data signal according to any preceding claim recorded thereon.

10. A data carrier according to claim 9, wherein the control data comprises one or more computer program software portions which when executed in an execution environment cause said carrier to be treated incorrectly as a carrier of another type.

11. A data carrier according to claim 10, wherein the second data set comprises one or more computer program software portions which when executed in an execution environment correctly identify the type of said carrier.

12. A data carrier according to claim 9, wherein the control data comprises modified table of contents (TOC) data that incorrectly specifies a starting address of said source data on said carrier.

13. A data carrier according to claim 12, wherein the second data set comprises TOC data that correctly specifies a starting address of said source data on said carrier.

14. A data carrier according to claim 9, wherein the control data comprises timing data associated with respective portions of said source data, at least part of said timing data being recorded non-monotonically on said carrier.

15. A data carrier according to claim 14, wherein the second data set comprises monotonically recorded timing data associated with respective portions of said source data.

16. A data carrier according to claim 9, wherein the control data introduces errors at predetermined points in said intermediate data set upon reading of said signal using equipment adapted to read data on a block by block basis.

17. A data carrier according to claim 16, wherein said second data set comprises portions of source data which may be used to replace said error inducing control data.

18. A method of generating a digital data signal according to any of claims 1 to 8, the method comprising the steps of: inserting control data into a first data set of source data, and providing in association with said first data set a second data set, wherein upon copying of said signal by equipment adapted to read data from said carrier on a block by block basis said source data is modified in accordance with said control data to generate an intermediate set of modified data, and said second data set is provided to enable modifications made or modifications that otherwise would be made to said first data set upon copying thereof to be at least substantially negated.

19. A method of copying data on a carrier according to any of claims 9 to 17 by means of a copy operation of equipment adapted to read data from said carrier on a block by block basis, the method comprising the steps of: copying said signal to cause said intermediate data set to be generated, accessing said second data set to retrieve data therefrom, and applying said retrieved data from said second data set to said intermediate data set to reverse modifications made in accordance with said control data upon copying of said signal.

20. A method of copying data on a carrier according to any of claims 9 to 18 by means of a copy operation of equipment adapted to read data from said carrier on a block by block basis, the method comprising the steps of: copying data from said second data set, modifying said read operation in accordance with said data copied from said second data set, and copying data from said first data set.

21. A computer program comprising one or more computer program software portions which when executed in an execution environment is configured to perform one or more of the method steps of claim 19 or 20.

22. Data copying equipment operable to copy data on a block by block basis from a digital data signal according to any of claims 1 to 8 or a digital data signal recorded on a carrier according to any of claims 9 to 17, said reading equipment comprising means for maintaining an execution environment and a computer program according to claim 21 executable in said execution environment.

23. A data transfer system comprising data storage means for a plurality of digital data signals according to any of claims 1 to 8, each of said data signals being associated with a respective set of source data; and transmission means for transmitting initially at least part of one or more of said first data sets to a receiving device, and subsequently transmitting second data sets associated with said transmitted first data sets.

24. A data transfer system according to claim 23, wherein the system comprises means for preventing transmission of said associated second data sets until authorisation has been received.

25. A data transfer system according to claim 24, comprising means for determining when payment in respect of first data sets for which said second data sets are to be transmitted has been received, and for subsequently providing said authorisation to said transmission preventing means.
